(19) United States
(12) Patent Application Publication
(10) Pub. No.: US 2007/0153304 A1
(43) Pub. Date: Jul. 5, 2007

(54) Method and apparatus for gray value identification for white balance

(75) Inventors: Ilia Ovsiannikov, Studio City, CA (US); Dmitri Jerdev, South Pasadena, CA (US)

Correspondence Address: DICKSTEIN SHAPIRO LLP, 1825 EYE STREET NW, Washington, DC, 20006-5403, US

(73) Assignee: Micron Technologoy, Inc.

(21) Appl. No.: 11/319,403

(22) Filed: Dec. 29, 2005

(51) Int. Cl. G06F 15/00

(52) U.S. Cl. 358/1.9

(57) ABSTRACT

A method and apparatus are provided for determining which pixels of a plurality of pixels have outputs which are reflecting of the color temperature of a light source. Those pixels which are determined to be representative of a light source may be used in a white balance operation. In the method and apparatus of the invention, the pixels are examined for a relationship among the color components (e.g., R, G, B) of a pixel which meet a predetermined criteria. Those pixels which meet the criteria are used in a white balance operation.

### FIELD OF THE INVENTION

The present invention relates generally to semiconductor imagers. More specifically, the present invention relates to a technique for setting a white balance for an image generated by a semiconductor imager.

### BACKGROUND OF THE INVENTION

Semiconductor imagers are used in a variety of digital image capture systems, including products such as scanners, copiers, and digital cameras. A semiconductor imager typically includes a pixel array, an array of light-sensitive pixel cells that are electrically responsive to incident light. Each cell in a pixel cell array includes a photosensor for converting incident photons into charge. The collected charge in each cell is output as a pixel signal voltage. The collective pixel signal voltages are processed to generate a digital version of the captured image.

FIG. 1 illustrates a block diagram of an exemplary semiconductor CMOS imager 100 having a pixel array 140 comprising a plurality of pixel cells arranged in a predetermined number of columns and rows. Each pixel cell is configured to receive incident photons and to convert the incident photons into electrical signals. The pixel array 140 often comprises at least three different types of pixel cells. Pixel cells may contain photosensors that are only sensitive to a certain band of wavelengths. For example, some photosensors are only sensitive to red light, others are only sensitive to green light, and still others are only sensitive to blue light. Alternatively, the array may be covered by a color filter array such that each pixel receives light associated with only a particular color (e.g., red, green or blue). Thus, pixel cells may be characterized as red pixel cells (i.e., pixel cells with photosensors that sense red light), green pixel cells and blue pixel cells.

The arrangement of pixel cells in pixel array 140 may vary. In a pixel array comprising only red, green and blue cells, a Bayer Color Filter Array (CFA) pattern is often used. In the Bayer pattern, red, green and blue light filers are placed over pixel cells to form red, green and blue pixel cells which are arranged in a checkerboard-like pattern so as to ensure an equal distribution of various types of pixel cells. This results, however, in each pixel cell only outputting a voltage representing a band of wavelengths corresponding to the color of the cell. For example, a red pixel cell only outputs a voltage representing the amount of photons corresponding to red light that is received by that pixel cell. Ideally, the pixel cell would also output signals representing the amounts of photons corresponding to green and blue light that are incident to the pixel cell. Instead, in the case of a red pixel cell, green and blue output values may be interpolated from the outputs of the neighboring green and blue pixel cells. Because this interpolation process requires the evaluation of multiple pixel outputs from multiple adjacent pixel cells, the process is referred to as a demosaic operation. Through a demosaic operation, representative red, green and blue output values may be determined for each pixel cell.

Pixel array 140 of FIG. 1 is arranged using the Bayer pattern. Thus, alternating rows of pixels have alternating green and red pixels. The other pixel rows have alternating blue and green pixels. Pixel cells of pixel array 140 are output row-by-row as activated by a row driver 145 in response to a row address decoder 155. Column driver 160 and column address decoder 170 are also used to selectively activate individual pixel columns. A timing and control circuit 150 controls address decoders 155, 170 for selecting the appropriate row and column lines for pixel readout. The control circuit 150 also controls the row and column driver circuitry 145, 160 such that driving voltages may be applied. Each pixel cell generally outputs both a pixel reset signal V_{ref} and a pixel image signal V_{sig} which are read by a sample and hold circuit 161. V_{ref} represents a reset state of a pixel cell. V_{sig} represents the amount of charge generated by the photosensor in a pixel cell in response to applied light during an integration period. The difference between V_{sig} and V_{ref} represents the actual pixel cell output with common-mode noise eliminated. The differential signal (V_{ref}−V_{sig}) is produced by differential amplifier 162 for each readout pixel cell. The differential signals are then digitized by an analog-to-digital converter 175. The analog-to-digital converter 175 supplies the digitized pixel signals to an image processor 180, which forms and outputs a digital image.

In addition to forming a resulting digital image, the image processor 180 also applies various corrections to the array image to ensure that the resulting digital image reflects the actual image as closely as possible. The effects of fixed pattern noise and other noise sources may be removed or corrected for by the image processor 180. Other effects, such as accounting for a proper white balance, are also applied by the image processor 180.

The concept of white balance arises in connection with light source color temperature. All light sources have a specific light source color temperature. Incandescent light sources have a reddish color cast corresponding to a lower correlated color temperature. Other light sources have a bluish color cast corresponding to a higher correlated color temperature. A light source that emits purely white light has a correlated color temperature in between that of blue and red light. Thus, the light source color temperature has an effect on the appearance of a captured image. In the case of digital imagers, the photosensors in the pixel cells will sense the incoming light of any light sources in the image, and the resulting digital image has an effective color cast related to the color temperature of the light sources. For example, a digital image of a scene that is lit by an incandescent or tungsten light source will have a reddish color shift because incandescent light sources have a low color temperature that corresponds to a reddish color cast. A digital image of a scene lit by other light sources may have a blue color shift resulting from light sources that have a high color temperature corresponding to a bluish color cast.

In many instances, no color shift is desired in the resulting captured image. Or, conversely, a controlled color shift may be desired that differs from that which naturally occurs as a result of various light sources in the captured image. In the case where a color shift is to be removed, one may appropriately set the white balance to account for any color shifts resulting from non-white light sources. In digital imagers, the white balance may be set by appropriately gaining or amplifying the digital outputs of the pixel array for the different pixel colors. For example, in an red, green and blue array, as employed with a Bayer pattern, a picture with a bluish cast or one that is captured using a light source with a high color temperature may be made less blue by modifying the red, green and blue digital outputs accordingly to shift the overall color balance. The challenge, of course, is in determining to what degree to modify the red, green and blue digital outputs.

One solution for determining to what degrees digital outputs should be modified is to allow a user to specify the type of light source present in an image, and to then apply white balance adjustments to the image according to pre- or factory-determined settings for the given light source. This solution may be limited, however, by either restrictions on the number of predetermined light settings that may be selected, or the willingness or ability of a user to choose an appropriate setting from the available predetermined settings.

Another solution includes automatic detection of the image light source, and then application of white balance settings according to the detected light source. In this solution, an image processor selects a region of pixels to be analyzed for a determination of whether the pixels in the region are associated with pixel outputs for a light source. If the light source can be determined from the analyzed region of pixels, then the image processor applies a white balance setting to the entire image according to the determined light source.

The automatic detection method is successful if a light source can be determined, and if the determination of the light source is accurate, meaning that the actual light source and the determined light source are the same or nearly the same. Sometimes, however, the determined light source differs from the actual light source. The discrepancy is often the result of a mis-analysis of pixels within the selected region of pixels. For example, some pixels in the selected region of pixels may accurately reflect light cast from a gray light source. Other pixels in the selected region may not, and may instead reflect light cast from other light sources. By including both pixels representing gray light sources and pixels representing other light sources in a white balance calculation, the resulting white balance calculation using such pixels may result in an incorrect white balance determination. This problem may be eliminated by more effectively analyzing the selected region of pixels so that only pixels that represent a gray light source are included in the determination of what light source is present.

Thus, to improve white balancing and other image processing, a method and apparatus are desired that can effectively determine which pixels of a digital image are associated with pixel outputs that are representative of a light source, and then use those pixels in a white balance operation.

### BRIEF SUMMARY OF THE INVENTION

A method and apparatus are provided for determining which pixels of a plurality of pixels have outputs which are reflecting of the color temperature of a light source. Those pixels which are determined to be representative of a gray light source may be used in a white balance operation.

In the method and apparatus of the invention, the pixels are examined for a relationship among the color components (e.g., R, G, B) of a pixel which meet a predetermined criteria. Those pixels which meet the criteria are used in a white balance operation.

### BRIEF DESCRIPTION OF THE DRAWINGS

FIG. 1 is a block diagram of an exemplary semiconductor imager;

FIG. 2 shows a relationship between a calculated ratio and color temperature, according to an exemplary embodiment of the invention;

FIG. 3 is a block diagram of an image processing pipeline, according to an exemplary embodiment of the invention; and

FIG. 4 is a block diagram of an imaging processor system, according to an exemplary embodiment of the invention.

### DETAILED DESCRIPTION OF THE INVENTION

Photosensor outputs are partially dependent upon the color temperature of any incident light source. However, for a light source of any given color temperature, the ratio of a pixel's red, green and blue pixel outputs is relatively constant, as shown below in equation 1. For most light sources and for primary color filter arrays with dye and overall pixel spectral responses typical for the industry, the calculated ratio C(T) may be shown to be roughly constant between a range defined by Cₘᵢₙ and Cₘₐₓ (see equation 2).

$$\begin{matrix}C ( T ) = \frac{R ( T ) * B ( T )}{{G ( T )}^{2}} ≅ const .. & Equation 1 \\ {C}_{min} \leq C ( T ) \leq {C}_{max} . & Equation 2\end{matrix}$$

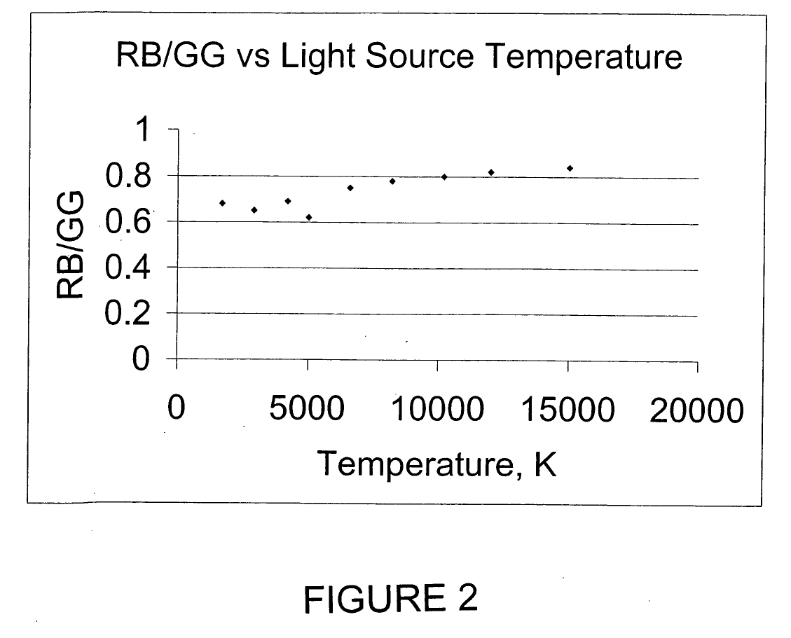

FIG. 2 shows sample values for the calculated ratio C(T) as a function of light source color temperature, as defined by equation 1. Note that, for the sample values shown, an upper and a lower threshold could be determined between which all illustrated C(T) values lie. Thus, in a captured digital image, red, green and blue pixel outputs may be evaluated using equation 1 to determine if the calculated ratio C(T) is within the range defined by equation 2. If the calculated ratio C(T) is within the defined range, then the evaluated pixel outputs are most likely representative of the temperature of a light source. If the calculated ratio C(T) for a pixel is within the defined range, then the pixel's outputs will be included in the determination of an appropriate white balance setting for the image. If, on the other hand, a pixel's calculated ratio C(T) is not within the range specified by equation 2, then the evaluated pixel outputs likely are not representative of the color temperature of a light source, and the evaluated pixel will not be included in the determination of a white balance for the image. By selecting only those pixels whose output meets the requirements of equation 2, the pixels used to determine the appropriate white balance more accurately reflect the color temperature of the light source for the image and a more accurate white balance may be set.

The thresholds Cₘᵢₙ and Cₘₐₓ may be determined by first referencing an ratio C(T) for a given sensor type and then determining an allowable lower and upper threshold for a range that includes the ratio C(T). The ratio C(T) may be found either experimentally for any given sensor type, as is shown in FIG. 2, or the ratio C(T) may be calculated using the known spectral response of the given photosensor type.

In order to evaluate whether a pixel cell's output should be included in the white balance statistics, a ratio C(T) must be calculated for each pixel cell (thus, Cᵢⱼ is calculated, where i refers to the i^{th} row and j refers to the j^{th} column of a pixel array). Referring to equation 1, this means that the calculation of every Cᵢⱼ would involve two multiplication operations and one division operation. Unfortunately, implementing these calculations for an entire pixel cell array or even a small region could be prohibitive in terms of calculation time and circuit complexity. The overall calculation time and circuit complexity could be reduced, however, if the multiplication and division operations are transformed to simple addition and lookup operations. This can be achieved by evaluating the conditions of equations 1 and 2 in the form shown below in equation 3 and then expanded in equation 4.

$$\begin{matrix}{Log}_{2} ( {C}_{min} ) \leq {Log}_{2} ( \frac{{R}_{ij} {B}_{ij}}{{G}_{ij}^{2}} ) \leq {Log}_{2} ( {C}_{max} ) . & Equation 3 \\ {Log}_{2} ( {C}_{min} ) \leq {Log}_{2} ( {R}_{ij} ) + {Log}_{2} ( {B}_{ij} ) - 2 * {Log}_{2} ( {G}_{ij} ) \leq {Log}_{2} ( {C}_{max} ) . & Equation 4\end{matrix}$$

Equation 4 expresses the same relationship as in equation 2, but in evaluating equation 4, no multiplications or divisions need be used. Instead, only additions and a logarithm function are used. To further simplify the necessary operations, the logarithm function may be implemented via a hardware or software lookup table. The lookup table may be constructed in a limited manner so as to reduce the number of lookup entries, as explained below. Also, since Cₘᵢₙ and Cₘₐₓ are determined in advance, the values of Log₂(Cₘᵢₙ) and Log₂(Cₘₐₓ) may be precalculated and loaded into storage locations, e.g., comparator registers, before any image processing commences.

The reduced lookup table for determining logarithms may be constructed according to the following guidelines. First, input data (in this case, Rᵢⱼ, Gᵢⱼ and Bᵢⱼ) is determined to be n-bits wide. Normally, a full lookup table would then include 2ⁿ entries. However, a sub-table Lₖ(x) can be constructed for input data with only k input bits, where k<n. The size of k is chosen in relation to the desired size of the sub-table, since the sub-table will have 2^{k} entries.

Despite the limited number of entries in the sub-table Lₖ(X), the sub-table Lₖ(X) may still be used to determine 2ⁿ lookup values. For input values that have n−k upper bits equal to 0, the sub-table is used directly in order to evaluate the input values as F(x) in accordance with equation 5.
F(x)=Lₖ(x) Equation 5.
Input values that have n−k−1 upper bits equal to 0 are instead evaluated according to equation 6. Equation 6 is valid because of the identity shown below in equation 7.

$$\begin{matrix}F ( x ) = {L}_{k} ( \frac{x}{2} ) + 1. & Equation 6 \\ {Log}_{2} ( 2 x ) = {Log}_{2} 2 + {Log}_{2} x = 1 + {Log}_{2} x . & Equation 7\end{matrix}$$

The term x/2 may be found by simply right-shifting the binary input value x.

By reapplying the identity of equation 7, lookup values may be calculated for input values that have n−k−2 or even n−k−q upper bits equal to 0. In the general case, where n−k−q upper bits are equal to 0, equation 8 applies.

$$F ( x ) = {L}_{k} ( \frac{x}{{2}^{q}} ) + q , where n - k - q \geq 0. \qquad Equation 8$$

Thus, a small lookup sub-table may be extended to work with a large number of input values. This way, the calculations required to solve equation 4 only involve additions, right-shifts and logarithmic functions (via lookup tables).

Returning again to equation 4, the calculation of Log₂(Cₘᵢₙ) and Log₂(Cₘₐₓ) may be simplified by preloading the calculated terms into a comparator. However, care must be taken to ensure that the loaded values are updated whenever an analog or digital gain is applied to the pixel readouts. By applying equations 9 and 10 below, the updated threshold values Log₂(C′ₘᵢₙ) and Log₂(C′ₘₐₓ) may be calculated using only addition, right-shifting and logarithmic lookup tables.
Log₂(C′ᵢⱼ)=Log₂(k_{R}Rᵢⱼ)+Log₂(k_{B}Bᵢⱼ)−2 Log₂(k_{G}Gᵢⱼ) Equation 9.
Log₂(C′ₘᵢₙ)=Log₂(k_{R})+Log₂(k_{B})−2 Log₂(k_{G})+Log₂(Cₘᵢₙ)
Log₂(Cₘₐₓ)=Log₂(k_{R})+Log₂(k_{B})−2 Log₂(k_{G})+Log₂(Cₘₐₓ) Equations 10.
The logarithms of the gain constants k_{R}, k_{B} and k_{G} may be precalculated and stored in a lookup table.

Lookup tables may be located in a micro-controller or on a micro-processor read-only memory (ROM). Alternatively, lookup tables may be implemented in a hardware pipeline.

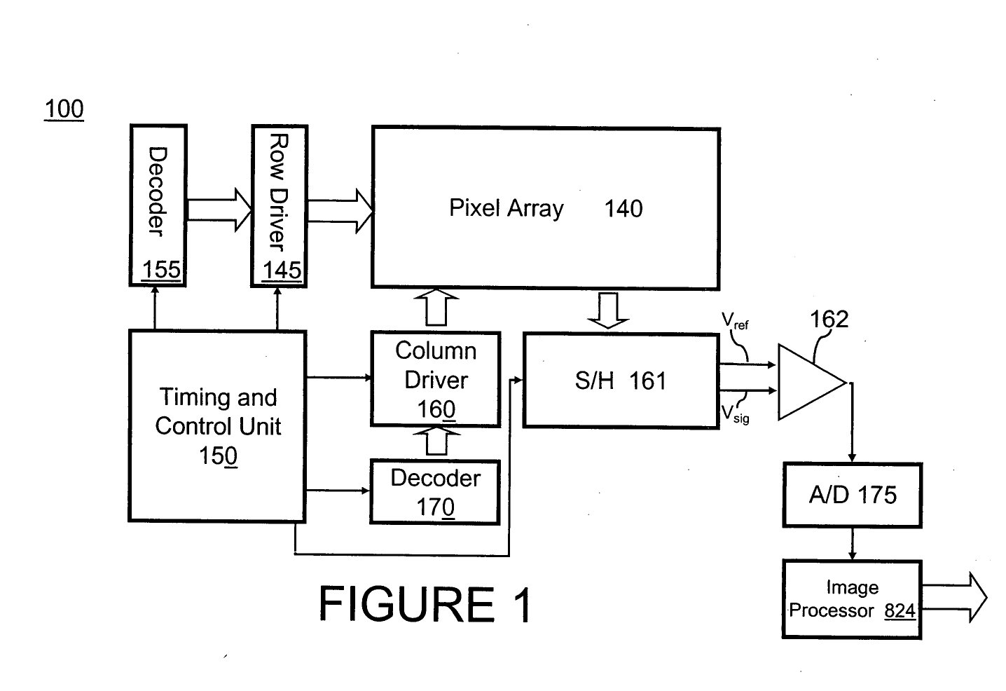

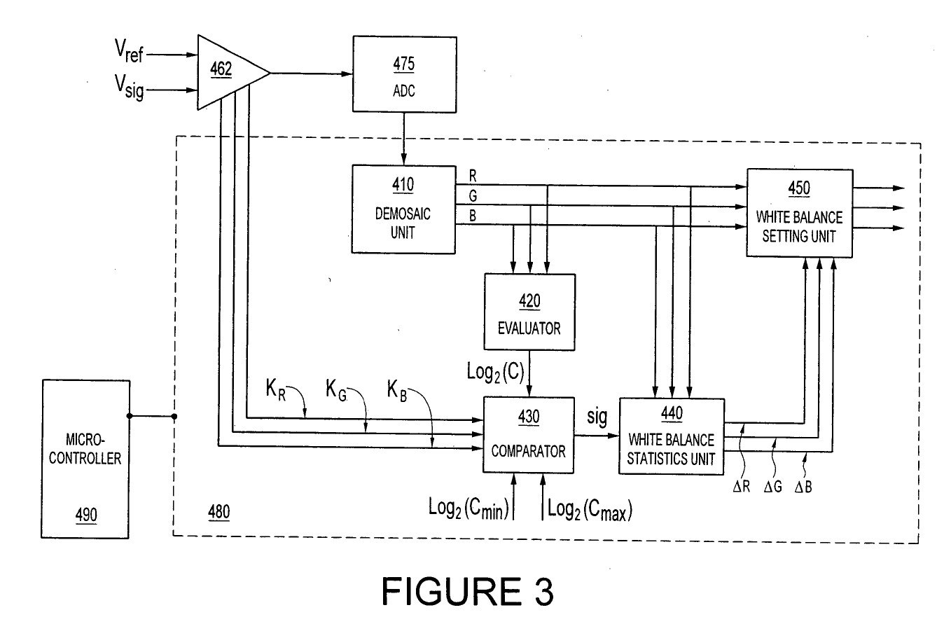

In an exemplary embodiment of the invention, as shown in FIG. 3, an image processing pipeline 480 is used, controlled by a micro-controller subsystem 490. The image processing pipeline 480 is an exemplary version of an image processing system such as that implemented within the image processor 180 (of FIG. 1). In FIG. 3, pixel outputs received from a pixel array by differential amplifier 462 may be subject to a gain operation. The amplified pixel output signals are digitized by an analog-to-digital converter 475. For each pixel, a red, green and blue digital pixel output is determined. If a Bayer pattern is used in the pixel array, the association of red, green and blue pixel outputs for each pixel will require a demosaic operation 410.

Each pixel's associated red R, green G and blue B pixel outputs are evaluated by evaluator 420. Evaluator 420 inputs a red, green and blue pixel output for each pixel and calculates a value Log₂(C) representing Log₂(Cᵢⱼ) for each pixel, as explained in equations 1-4. The calculated value Log₂(C) is then compared with the threshold values of Log₂(Cₘᵢₙ) and Log₂(Cₘₐₓ) by comparator 430. If a gain operation has occurred by amplifier 462, then modified threshold values Log₂(C′ₘₐₓ) and Log₂(C′ₘᵢₙ) are first calculated with reference to the gain factors k_{R}, k_{G} and k_{B}, as shown in equations 10. If the calculated value Log₂(C) is found to be bounded by the maximum and minimum thresholds, a signal Sig is sent to the white balance statistics unit 440, indicating to the unit that the evaluated pixel is representative of a color temperature of a light source.

White balance statistics unit 440 collects pixel output values for only those pixels that could represent the color temperature of a light source, as determined by the comparator 430. If the signal Sig is sent to the white balance statistics unit 440 from the comparator 430, the white balance statistics unit 440 will include the evaluated pixel outputs in its determination of an appropriate white balance setting for the image. When the signal Sig is not sent to the white balance statistics unit 440, the evaluated pixel is omitted from the determination of an appropriate white balance setting for the image. After the white balance statistics unit 440 has collected pixel outputs for those pixels that could represent a light source for the selected region of pixels, an appropriate white balance is determined and the associated shifts R_{avg}, G_{avg} and B_{avg} in the red, green and blue pixel outputs, respectively, are calculated as gain values and sent to the white balance setting unit 450 for application to the red, green and blue pixel outputs.

The above-described embodiments of the invention are directed towards determining appropriate pixel cell outputs for use in setting white balance for an image. The invention has been described in reference to an image processing pipeline. One skilled in the art will recognize, then, that the determination of pixel cells representing light sources may be implemented as either software integrated with the image processor or as a stand-alone software product stored on a carrier medium (e.g., computer readable storage medium, compact disc, server computer storage drive) and installed on a computer system. Additionally, one skilled in the art would recognize that hardware solutions could also be implemented.

Additionally, one skilled in the art will recognize that embodiments of the invention may be used in various types of digital image systems, including, but not limited to, complementary metal oxide semiconductor (CMOS) and charge-coupled device (CCD) systems and other imaging systems. Furthermore, although the described embodiments have been directed to a red, green and blue (RGB) color system, equations 1-10 may be converted to apply to other color systems, such as a hue, saturation and value (HSV) system or a hue, saturation and lightness (HSL) system.

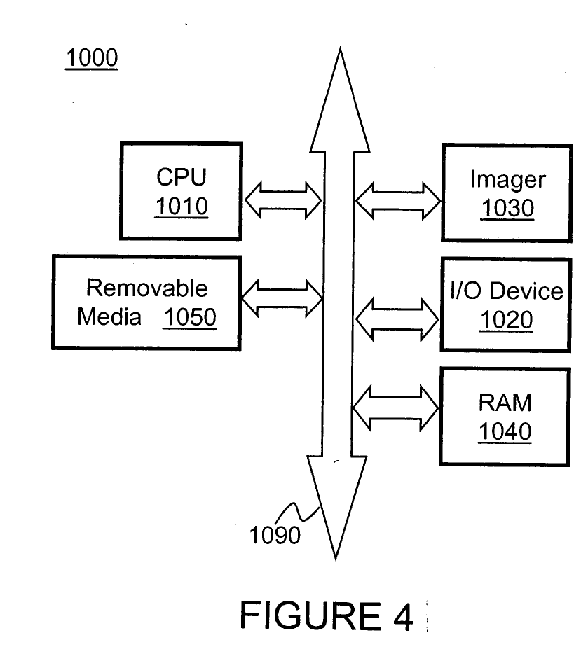

A typical processor system 1000, which includes an imager device 1030 according to the present invention is illustrated in FIG. 4. A processor system is exemplary of a system having digital circuits which could include imager devices. Without being limiting, such a system could include a computer system, camera system, scanner, machine vision system, vehicle navigation system, video telephone, surveillance system, auto focus system, star tracker system, motion detection system, or other image acquisition system.

A processor system, such as a camera system, for example, generally comprises a central processing unit (CPU) 1010, for example, a microprocessor, that communicates with an input/output (I/O) device 1020 over a bus 1090. The imager 1030 also communicates with the system components over bus 1090. The computer system 1000 also includes random access memory (RAM) 1040, and, in the case of an imaging system may include peripheral devices such as a removable memory 1050 which also communicates with CPU 1010 over the bus 1090. Imager 1030 is preferably constructed as an integrated circuit which includes pixels containing a photosensor, such as a photogate or photodiode. The imager 1030 may be combined with a processor, such as a CPU, digital signal processor or microprocessor, with or without memory storage in a single integrated circuit, or may be on a different chip than the processor.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above-described exemplary embodiments.

What is claimed as new and desired to be protected by Letters Patent of the United States is:

1. A method of white balance control comprising:
determining if a set of color pixel outputs for selected pixels of a captured image have a relationship which falls within the range of maximum and minimum threshold values; and
if said color pixel outputs have a relationship which falls within said range, using said set of color pixel outputs in a white balance calculation.

2. The method of claim 1, wherein said set of color pixel outputs are red (R), green (G) and blue (B) outputs and said relationship is C_{T}=RB/G².

3. The method of claim 2, wherein relationship C_{T} is determined without performing a multiplication or division operation.

4. The method of claim 2, wherein the calculated value is determined using only addition, register-shift and lookup operations.

5. An apparatus for determining which pixels of a plurality of pixels are associated with a set of color outputs generated in response to a light source having a predetermined color temperature, said apparatus comprising:
a calculating element configured to calculate a relationship between the set of color outputs for each pixel; and
a comparing element to determine whether the calculated relationship associated with each pixel is within a range bounded by a minimum and a maximum threshold,
and, if the relationship is within the range, to include the pixel's set of color outputs in a white balance calculation.

6. The apparatus of claim 5, wherein the set of color outputs comprises a red (R), a green (G) and a blue (B) color output and said relationship is C_{T}=RB/G².

7. The apparatus of claim 6, wherein the calculated value is determined without using a multiply or division operation.

8. The apparatus of claim 6, wherein the calculated value is determined using only addition, register-shift and lookup operations.

9. The apparatus of claim 6, further comprising a lookup table, wherein the lookup table has fewer than 2ⁿ entries, where the red, green and blue color outputs are data inputs each having n data bits, respectively.

10. The apparatus of claim 9, wherein the lookup table has only 2^{k} entries, where k is less than n.

11. The apparatus of claim 10, wherein the lookup table is configured to be used directly for data inputs that have n−k upper data bits equal to zero.

12. The apparatus of claim 10, wherein the lookup table is configured to be used for data inputs that have n−k−q upper data bits equal to zero by using the lookup table directly for data inputs right-shifted q times and then adding q to the lookup table result.

13. The apparatus of claim 9, wherein the lookup table is a logarithm lookup table.

14. The apparatus of claim 5, wherein the comparing element is configured to recalculate the minimum and maximum thresholds if the set of color outputs is subject to a gain operation.

15. The apparatus of claim 14, wherein the comparing element references a logarithm lookup table to find logarithms of gain constants that are added to the minimum and maximum thresholds during recalculation.

16. An apparatus for determining a relationship between a set of color outputs of a pixel, comprising:
a calculating element configured to calculate the relationship between the set of color outputs, wherein the set of color outputs comprises a red (R), a green (G) and a blue (B) color output and said relationship is C_{T}=RB/G²; and
a lookup table having fewer than 2ⁿ entries, where the red, green and blue color outputs are data inputs, each having n data bits, respectively.

17. The apparatus of claim 16, wherein the lookup table has only 2^{k} entries, where k is less than n.

18. The apparatus of claim 17, wherein the lookup table is configured to be used directly for data inputs that have n−k upper data bits equal to zero.

19. The apparatus of claim 17, wherein the lookup table is configured to be used for data inputs that have n−k−q upper data bits equal to zero by using the lookup table directly for data inputs right-shifted q times and then adding q to the lookup table result.

20. The apparatus of claim 16, wherein the lookup table is a logarithm lookup table.

21. An imager, comprising:
a pixel array wherein each pixel in the pixel array is associated with a set of color outputs;
a calculating element configured to calculate a relationship between the set of color outputs for each pixel; and
a comparing element for determining whether the calculated relationship associated with each pixel meets a predetermined criteria, and, if the relationship meets said criteria, for including the pixel's set of color outputs in a white balance calculation.

22. The imager of claim 21, wherein the predetermined criteria is that the calculated relationship is within a range bounded by a minimum and a maximum threshold

23. The imager of claim 22, wherein the set of color outputs comprises a red (R), a green (G) and a blue (B) color output and said relationship is C_{T}=RB/G².

24. The imager of claim 23, wherein the relationship is determined without using a multiply or division operation.

25. The imager of claim 23, wherein the relationship is determined using only addition, register-shift and lookup operations.

26. The imager of claim 23, further comprising a lookup table, wherein the lookup table has fewer than 2ⁿ entries, where the red, green and blue color outputs are data inputs each having n data bits, respectively.

27. The imager of claim 26, wherein the lookup table has only 2^{k} entries, where k is less than n.

28. The imager of claim 26, wherein the lookup table is a logarithm lookup table.

29. An imaging system, comprising:
a processor; and
an imager associated with said processor, comprising:
a pixel array wherein each pixel in the pixel array is associated with a set of color outputs;
a calculating element configured to calculate a relationship between the set of color outputs for each pixel; and
a comparing element to determine whether the calculated relationship associated with each pixel is within a range bounded by a minimum and a maximum threshold, and, if the relationship is within the range, to include the pixel's set of color outputs in a white balance calculation.

30. The imaging system of claim 29, wherein the set of color outputs comprises a red (R), a green (G) and a blue (B) color output and said relationship is C_{T}=RB/G².

31. The imaging system of claim 29, wherein the relationship is determined without using a multiply or division operation.

32. The imaging system of claim 29, wherein the relationship is determined using only addition, register-shift and lookup operations.

33. The imaging system of claim 29, further comprising a lookup table, wherein the lookup table has fewer than 2ⁿ entries, where the red, green and blue color outputs are data inputs each having n data bits, respectively.

34. The imaging system of claim 33, wherein the lookup table has only 2^{k} entries, where k is less than n.

35. The imaging system of claim 34, wherein the lookup table is configured to be used directly for data inputs that have n−k upper data bits equal to zero.

36. The imaging system of claim 34, wherein the lookup table is configured to be used for data inputs that have n−k−q upper data bits equal to zero by using the lookup table directly for data inputs right-shifted q times and then adding q to the lookup table result.

37. A carrier medium carrying a program that, when executed by a processor, causes the processor to perform the acts of:
determining if a set of pixel outputs for selected pixels of a captured image have a relationship which falls within the range of maximum and minimum threshold values; and
if said pixel outputs have a relationship which falls within said range, using said set of pixel outputs in a white balance calculation.

38. The carrier medium of claim 37, wherein the set of pixel outputs comprises a red (R), a green (G) and a blue (B) color output and said relationship is C_{T}=RB/G².

39. The carrier medium of claim 38, wherein the relationship is determined without using a multiply or division operation.

40. The carrier medium of claim 38, wherein the relationship is determined using only addition, register-shift and lookup operations.

41. The carrier medium of claim 38, further comprising creating a lookup table, wherein the lookup table has fewer than 2ⁿ entries, where the red, green and blue color outputs are data inputs each having n data bits, respectively.

42. The carrier medium of claim 41, wherein the lookup table has only 2^{k} entries, where k is less than n.
